(19) United States
(12) Patent Application Publication
(10) Pub. No.: US 2015/0159954 A1
(43) Pub. Date: Jun. 11, 2015

(54) System and Method for Charging a Furnace for Melting and Refining Copper Scrap, and Furnace Thereof

(71) Applicant: La Farga Lacambra, S.A.U., Barcelona (ES)

(72) Inventors: Gabriel Font Puig, Barcelona (ES); Francesc Farriol Almirall, Barcelona (ES); Oriol Guixa Arderiu, Barcelona (ES); Miquel Garcia Zamora, Barcelona (ES)

(21) Appl. No.: 14/310,454

(22) Filed: Jun. 20, 2014

(30) Foreign Application Priority Data
Dec. 11, 2013 (ES) 20133803

(51) Int. Cl. F27D 3/00; C22B 15/00; F27D 99/00; F27B 3/06; F27B 3/18; C22B 9/02; C22B 1/00

(52) U.S. Cl. CPC F27D 3/0024; C22B 9/02; C22B 15/006; C22B 1/005; F27B 3/065; F27B 3/18; F27D 99/00

(57) ABSTRACT

System and method for charging a furnace for melting and refining copper scrap, comprising at least one shredder intended to receive copper scrap to be refined, associated with screening means linked to at least one vibrating feeder table through continuous conveyance means, such that said vibrating feeder table allows shredded copper scrap to be put into the furnace. A furnace is also described which is suitable for receiving a volume of copper scrap from the above charging system and method, characterized by a flat vault with a horizontal charging door, whose opening width for receiving the charge of shredded scrap is less than 0.6 m. The system, method and furnace described make it possible to optimize the process of melting and refining copper scrap, as well as reduce the consumption of energy and the emission of polluting gases.

### CROSS REFERENCE TO RELATED APPLICATIONS

This application claims priority of ES Application No. 201331803 filed Dec. 11, 2013, which is incorporated by reference herein in its entirety.

### OBJECT OF THE INVENTION

The object of the present Invention Patent application is to register a charging system, and a method and a furnace that incorporate notable innovations and advantages.

More specifically, the invention proposes the development of a system and method for charging a furnace for melting and refining copper scrap, and of the furnace for melting and refining copper scrap, which make it possible to optimize the melting and refining process, as well as reduce the consumption of energy and the emission of polluting gases.

### BACKGROUND OF THE INVENTION

There is a wide variety of furnaces and methods for refining copper. Their design obviously depends on the purity of the raw material to be used, as well as the subsequent use of the liquid molten metal obtained at the end of the pyrometallurgical process carried out in the furnace.

We can divide the furnaces and the charging systems and methods used for refining copper into two large groups:

1.—For continuous charging and melting furnaces, the most important ones are:

a.—Shaft furnace, according to U.S. Pat. No. 3,199,977, schematically represented in FIG. 1, wherein charging is carried out via the opening 101; as the fire place 102 of the furnace is vertical, and the combustion system is in the lower section of the furnace 103, the combustion gases pass through the charge, producing high energy performance, and the melted material flows over the furnace sole 104 through the outlet hole 105. The slag from copper scrap is very sticky, meaning this type of furnace allows for very pure copper materials to be melted, since otherwise the furnace sole 104 would fill up with slag.

b.—Hearth-shaft furnace, according to patent GB1056977, schematically represented in FIG. 2, wherein charging is carried out via the opening 201; the charge 202 is heated by the combustion gases of the burners 203, and the material flows over the firebridge 204 that is necessary in order to be able to accumulate liquid copper in the area 205. In order to release this copper, the furnace can be tilted on the floor bearings, which means that the vertical portion 206 must be made shorter, thus significantly decreasing the intended energy performance.

c.—Cosmelt Process® furnace; this is a pyrometallurgical process and furnace designed by La Farga Lacambra in the year 2000. This furnace is schematically represented in FIG. 3, wherein charging is carried out via the opening 301; as the fire place 302 of the furnace is vertical and the combustion system is in the lower section of the furnace 303, the combustion gases pass through the charge, producing high energy performance, and the melted material flows over the furnace sole 304, which is covered in liquid copper, allowing copper and slag to flow towards the outlet box 305. This solution makes it possible to charge and melt copper scrap with contents of more than 97% with high energy performance.

2.—For batch-type charging and melting furnaces, the most important ones are:

a.—Reverberatory furnace, originally designed in the 50s by Maerz, according to U.S. Pat. No. 2,864,602, schematically represented in FIG. 5 in a more recent version. This furnace is able to melt copper scrap with a content of at least 92%. This furnace can be tilted, preferably through a system of wheels or rollers 501 and hydraulic cylinders 502, to facilitate the processes of emptying and deslagging. The charging door 503 is situated on one of the sides, making it hard to insert copper scrap since the charge must be distributed inside the furnace so as to keep it from accumulating in the vicinity of the door. The opening time is high, with a great amount of energy lost as a result. Likewise, it is very difficult to collect the combustion gases that exit through the charging door.

b.—Turret furnace, according to patent application WO2012038140, schematically represented in FIG. 6. This furnace is also of the tilting reverberatory type, and is characterized by having, in the central part of the vault, a turret that protrudes and has an arched ceiling 601 delimited by the charging door of the furnace 602. The aim of this solution is to increase furnace capacity and facilitate the charging process. The main drawback of this furnace is its low energy efficiency, since opening the charging door brings about the stack effect, with a resulting loss of heat. At this point it is worth mentioning that the previously-described turret-charging furnaces, i.e. the shaft, Cosmelt and hearth-shaft varieties, also have said stack effect, and channel the gases through the material to be melted and towards the exit stack, which is not so in the case of the turret furnace.

c.—Elliptical furnace, according to patent ES2271898, schematically represented in FIG. 4. This furnace has an elliptical or oval-shaped transverse cross-section, and can rotate around its rotation axis by an angle of more than 40°, typically 90°. The proper melting position (FIG. 4) is when the surface of the bath 401 is greater than its depth 402h. The proper refining and mixing position is when the surface of the bath is less than its depth. The limitation of this furnace is its small capacity of between 20 and 50 mt. The fact that it is charged from the side has the same drawbacks as those described for the furnace in FIG. 5.

d.—Cylindrical furnace, also known as a drum furnace, according to U.S. Pat. No. 4,245,821, represented schematically in FIG. 7. Usually the melting process takes place in another furnace, and the drum furnace is used to refine the molten copper. When used for melting, it has problems in terms of both charging and heat loss. In order to generate a proper exchange between the additive and the liquid copper, given the great difference in their density, bath surfaces 701 must be large, avoiding bath depths 702h greater than 700 mm. Cylindrical-type furnaces hinder this exchange, as they are furnaces with large depths of liquid copper.

As for the copper scrap used to feed these batch-type charging and melting copper-refining furnaces, the initial copper content may be 92%; normally copper scrap with a copper content of 92% to copper scrap with 99.9% is used. There are various specifications on the market for referring to copper scrap, the most commonly used of which are the ISRI and EN-12861 specifications. In the ISRI guidelines, which is the most widely-consulted internationally, the scrap that may be used with this invention are referred to as “MillBerry/Barley”, “Berry”, “Birch”, “Candy”, “Cliff”, “Clove”, “Cobra”, “Cocoa”, and “Dream”; in the EN-12861 standard, this corresponds to the codes S-Cu-1, S-Cu-2, S-Cu-3, S-Cu-4, S-Cu-5, S-Cu-6, S-Cu-7, S-Cu-8, S-Cu-9, S-Cu-10; i.e. scrap with a copper content of more than 92%.

Obviously, these copper scraps may have different physical forms (pellets, scraps of piping, old wire, catenary, ingots, solid pieces, sheets, enameled wire, paper-covered wire, etc.). In addition to the lack of homogeneity, a general characteristic is the significant and variable presence of inert substances, such as ash, rust and earth. The actual quantity of said inert materials is critical when evaluating the copper content of scrap, as well as in the melting and refining thereof.

The pyrometallurgical process of copper consists of a set of phases, the first of which is charging the copper scrap into the furnace. To do so, loaders or trucks are typically employed, or lifting systems with skips, or other systems. Given that the amount charged is limited by the capacity of the loaders, trucks or skips, the furnace door must be opened several times for the furnace to be completely charged, with the loss of energy that this entails. Moreover, with these charging systems it is not possible to optimize the space taken up by the scrap, which are not homogeneous in shape and size, and require the size of the opening of the charging door of the furnace to have dimensions large enough to receive the loader, or the wagon truck, or the skip.

Subsequently this scrap must be melted by providing the heat necessary to raise the temperature to copper's melting point of 1083° C. and provide the calories necessary for the 205 kJ/kg latent heat of fusion.

Generally, this operation is at present carried out in phases; once the entire charge in the furnace has been melted, the temperature is increased to the working temperature, between 1150° C. and 1200° C.

Second, because the furnace has been charged with material whose copper content is less than 100%, part of this material which is not copper will not have melted, such as earth, and various materials with a melting point of more than 1200° C. As such, there must be a phase for extracting these materials, whose densities are lower than that of copper and so float on the surface; additives are generally added to optimize this process.

Once copper and metal impurities have been left in the furnace, the copper refining operation known to the state of the art is carried out, which is an oxidation-reduction process with the addition of elements that carry away the various impurities.

Lastly, through the pyrometallurgical refining process liquid molten copper is obtained, the composition of which may be adjusted as desired, and which may correspond to the following designations, among others:

| | | Minimum | |
|---|---|---|---|
| | | Cu + Ag | |
| Symbol | Designation | content | Main reference standards |
| FRTP | “Fire-refined touch-pitch” | 99.90% | ASTM B224; EN 1976 |
| FRSTP | “Fire-refined touch-pitch with silver” | | ASTM B224 |
| STP | “Silver-bearing touch-pitch” | | ASTM B224 |
| CuAg0.04 | “Silver-bearing touch-pitch” | | EN 1976 |
| CuAg0.07 | | | |
| CuAg0.10 | | | |
| CuAg0.04P | “Deoxidized silver-bearing” | | EN 1976 |
| CuAg0.07P | | | |
| CuAg0.10P | | | |
| FRHC | “Fire-refined high conductivity touch-pitch” | | ASTM B5; EN 1976 |
| DLP | “Phosphorized low-residual phosphorous” | | ASTM B224; EN 1976 |
| DLPS | “Phosphorized low-residual phosphorous | | ASTM B224 |
| | silver-bearing” | | |
| DHP | “Phosphorized, high-residual phosphorous” | | ASTM B224; EN 1976 |
| DXP | | | EN 1976 |
| DHPS | “Phosphorized, high-residual phosphorous | | ASTM B224 |
| | silver-bearing” | | |
| CuSn0.15 | “Tin-bearing touch-pitch” | 99.75% | EN TS 13388 |
| CuSn0.4 | | 99.35% | |

In the current state of the art the following issues have not been resolved:

1.—Loss of energy efficiency due to non-metal materials that accompany copper scrap, as copper scrap are accompanied by non-metal impurities that cause loss of energy, as these materials must be melted if they are charged into the furnace.

2.—Loss of energy efficiency due to the fact that the non-metal materials mentioned in section 1 are heat insulators, and so once the copper has melted these lighter materials float on the surface of the liquid molten metal, leading to poor heat transmission.

3.—These non-metal materials charged into the furnace cause a significant increase in slag.

4.—Loss of energy efficiency in a reverberatory furnace, due to the fact that the commercial forms of copper scrap do not allow for proper heat exchange between the burner flames and the charge, leading to low melting performance.

5.—Decrease the number of times the charging door of the furnace is opened, in order to obtain very high energy performance as compared to the methods known in the state of the art.

6.—Minimize the necessary section of the charging door, in order to obtain very high energy performance as compared to the methods known in the state of the art.

In regards to points 5 and 6, a heat exchange is created with the space outside the furnace through the charging door, bringing about a heat shock to the refractory material on the furnace walls, which is why it is crucial to open this door the fewest number of times possible and likewise minimize the opening section.

7.—Improve the distribution of the material to melt inside the furnace, to allow for proper heat transmission between the charge and the melting flame.

8.—Gas cleaning: in the process of refining scrap, a significant volume of gases are generated, which are to be processed before being emitted into the atmosphere. These gases produced by combustion are mainly conducted through the extraction stack of the furnace; as such, they have a defined volume and are properly channeled. This is not so in the case of so-called secondary emissions; because they are emissions brought about by opening up the furnace, and very specifically by opening the charging door, these gases are difficult to channel due to the large quantity of gas that is released. We must also bear in mind that during the process of charging copper scrap, when the latter come into contact with the atmosphere of the hot furnace, they generate a high volume of combustion gases due to the nature of the charge, since, as has been mentioned, copper and metal impurities are accompanied by a large amount of non-metal material that combusts and becomes volatile, and highly pollutant.

### DESCRIPTION OF THE INVENTION

The present invention has been developed for the purpose of providing a system and method for charging a furnace for melting and refining copper scrap, as well as the furnace for melting and refining copper scrap, that overcomes the aforementioned drawbacks, moreover offering other additional advantages that will become clear in light of the accompanying description below.

Therefore, one object of the present application is a system for charging a furnace for melting and refining copper scrap, comprising at least one shredder intended to receive copper scrap to be refined, associated in turn with screening means intended to receive copper scrap that has been shredded by said shredder, wherein said screening means are linked to at least one vibrating feeder table through continuous conveyance means, wherein said vibrating feeder table is configured so as to allow shredded copper scrap to be put into the furnace.

These characteristics give rise to system and method for charging a furnace for melting and refining copper scrap that allows for prior shredding and screening of said copper scrap. In this way, the energy efficiency of the copper scrap refining process is improved, as it is not necessary to melt the material impurities thereof, which are separated out with the screening means; the effects of these impurities as heat insulators on the surface of the liquid molten metal is avoided or substantially reduced; the presence of slag in the liquid molten metal is reduced; the energy efficiency in the furnace is improved as, by shredding the copper scrap, the commercial forms of said copper scrap are broken down and homogenized in order to obtain proper heat exchange between the burner flame and the charge, thus improving melting performance; reducing the presence of material impurities in the volume of scrap inserted through the opening of the furnace, in turn reduces the emission of materials that become volatile and cause pollution upon contact with the atmosphere. Likewise, the distribution of the material to melt inside the furnace is improved, giving rise to the pyramid effect, which allows for proper heat transmission between the charge and the melting flame.

Preferably, the screening means may comprise a screening drum and/or a vibrating separator device; in addition the continuous conveyance means may preferably have a conveyor belt. As for the shredder, is has been provided that it may be of the cutter mill type, such that the size of the shredded copper scrap particles to be charged into the refining furnace is of 100 to 150 mm in length.

The vibrating table is designed to prevent damage to the continuous conveyance means caused by the heat coming out of the furnace.

The charging system may advantageously have at least one secondary-gas extraction unit, comprising an extraction conduit from the vicinity of the charging door of the furnace, wherein said extraction conduit may be linked up to a gas cleaning station which is not part of the present invention. This unit makes it possible to conduct and properly process secondary emissions or fumes when the charging door of the furnace is opened.

Another object of the present invention is a furnace for melting and refining copper scrap, particularly of the tilting reverberatory type, which comprises a flat vault, wherein said flat vault is equipped with a horizontal charging door, the opening of said charging door being suitable for receiving a volume of copper scrap from the aforementioned charging system.

In the present description, “horizontal” shall be understood to be the direction or plane that is essentially parallel to the flat vault of the furnace.

Advantageously, in the melting and refining furnace, the maximum opening width necessary for the charging door of the furnace is less than 0.6 m, preferably equal to or less than 0.5 m. In addition, the opening surface of the charging door of the furnace for charging the shredded copper scrap is advantageously from 0.45 m² to 0.9 m².

These characteristics improve the energy performance of the process of melting and refining copper scrap, as the horizontal door on the flat vault makes it possible to directly and continuously receive the volume of copper scrap fed in homogeneously by the vibrating table in coordination with the opening of said horizontal door. Moreover, the aforementioned dimensions enable an additional reduction to the heat that the furnace loses to the outside. The positioning of the door on the flat vault facilitates the installation of the secondary emissions extraction conduit.

The location of the charging door on the flat vault facilitates the insertion of copper scrap and the distribution of the material to melt inside the furnace, to allow for proper heat transmission between the charge and the melting flame. Likewise, the stack effect is substantially reduced, and the collection of secondary emissions is facilitated. Since the charging door is in the vault, it is possible to design a metallic structure that is much more rigid as a whole.

An additional object of the present application is a method for charging a furnace for melting and refining copper scrap, which comprises the following stages:

a) shredding the copper scrap to be refined; wherein the size of the shredded copper scrap particles is preferably between 100 and 150 mm in length.
b) screening out non-metal elements present in the copper scrap to be refined; wherein said non-metal elements present in the copper scrap to be refined are mostly earth materials.
c) conveyance of the copper scrap to be refined;
d) opening a charging door of the furnace;
e) feeding the copper scrap to be refined into the furnace, particularly by vibration, thus improving the distribution of the material to be melted inside the furnace.

Advantageously, at least 5% of the total capacity of the furnace is put into the furnace per minute, and the furnace is opened for charging a maximum of 20 times. In addition, a flow of secondary emissions of less than 3 kg/h per ton of furnace capacity is extracted. This flow may be easily extracted due to the presence of a conduit linked to the horizontal charging door. The energy needed to melt the copper scrap that is fed into the furnace is less than 535 kWh/mt for furnaces of between 50 and 500 mt.

Due to these characteristics, it is possible to decrease the number of times the charging door of the furnace is opened as compared to the methods known in the state of the art, thus obtaining better energy performance, since the exchange of heat with the area outside the furnace is reduced.

Other characteristics and advantages of the system, the method and the furnace for refining copper scrap, which are the object of the present invention, will become clear in light of the description of a preferred, though non-exclusive, embodiment, which, by way of a non-limiting example, is illustrated in the accompanying drawings, wherein:

### BRIEF DESCRIPTION OF THE DRAWINGS

FIGS. 1-7.—Are views of charging systems of various furnaces for refining copper scrap found in the state of the art, wherein dashed lines have been used to represent the initial position of some furnace charging devices;

FIG. 8.—Is a schematic elevation view of the system and furnace in transverse cross-section, in accordance with the present invention, during charging thereof;

FIG. 9.—Is a schematic view in transverse cross-section of the furnace in FIG. 8, during charging thereof;

FIG. 10.—Is a schematic view in longitudinal cross-section of the furnace in FIG. 8, during charging thereof; and

FIG. 11.—Is a schematic perspective view of the furnace in accordance with the invention, equipped with a conduit for extracting secondary emissions.

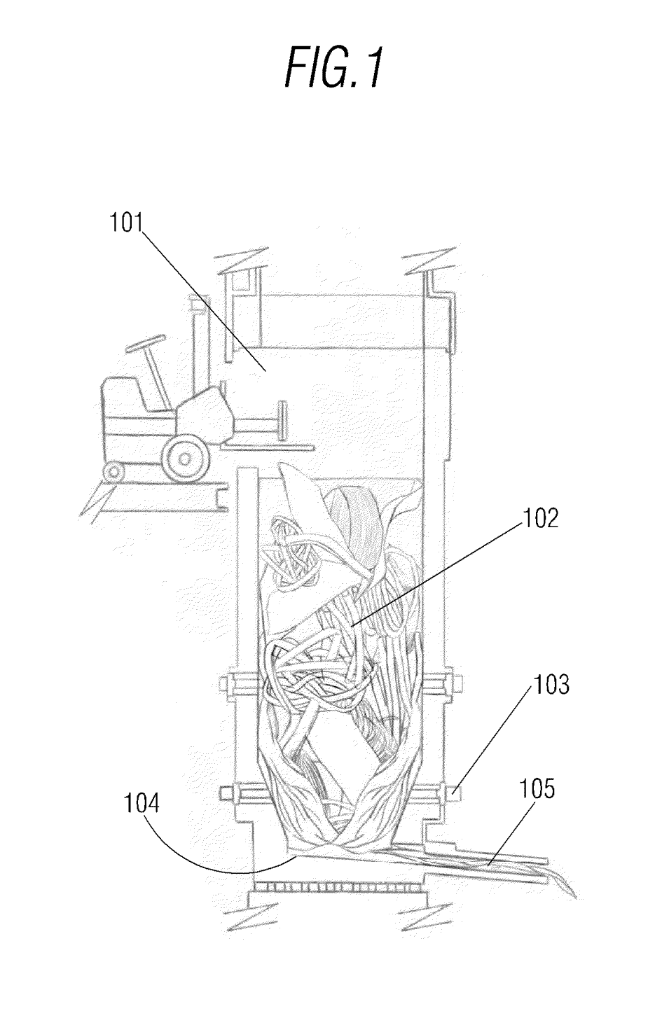

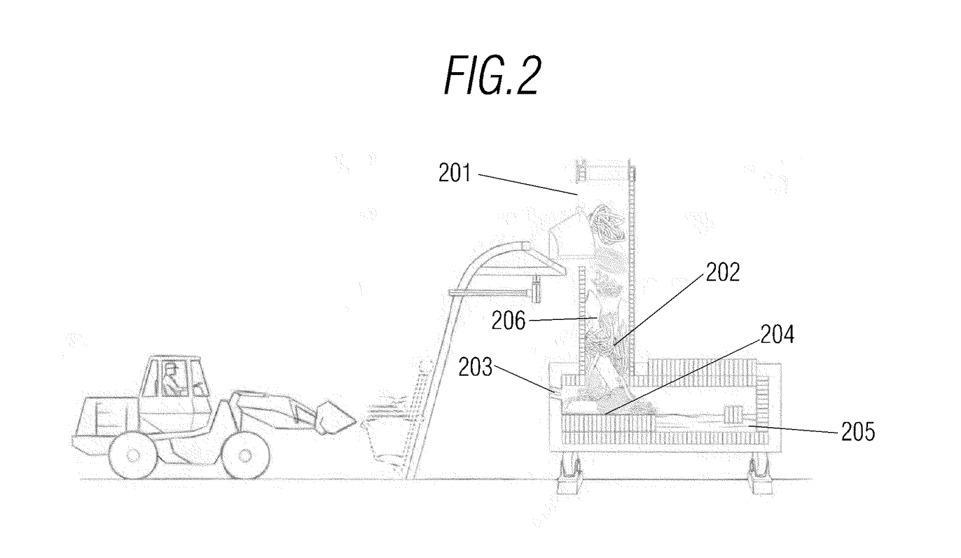

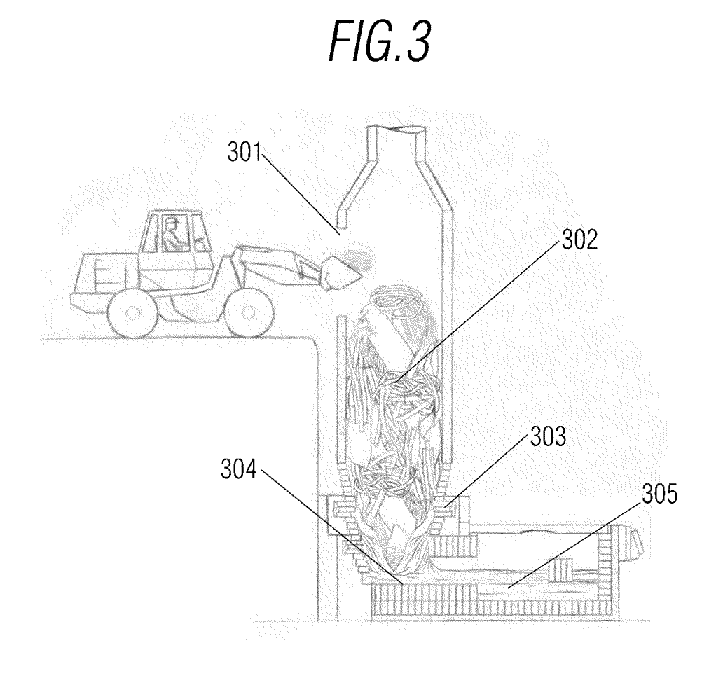

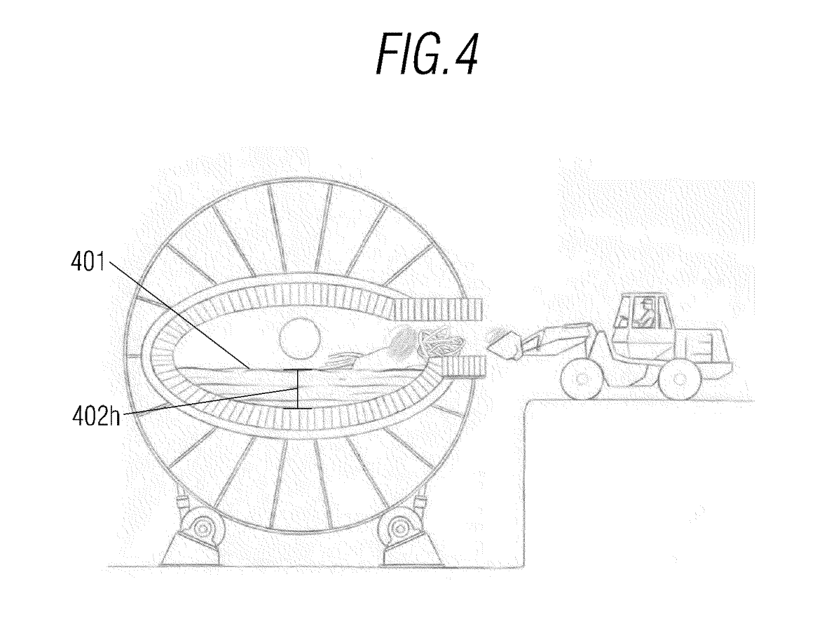

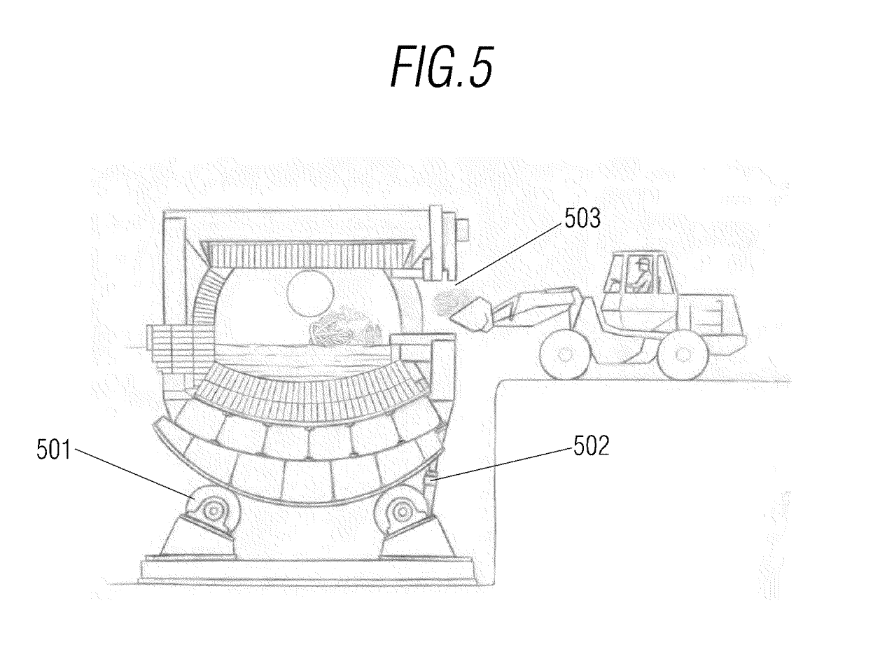

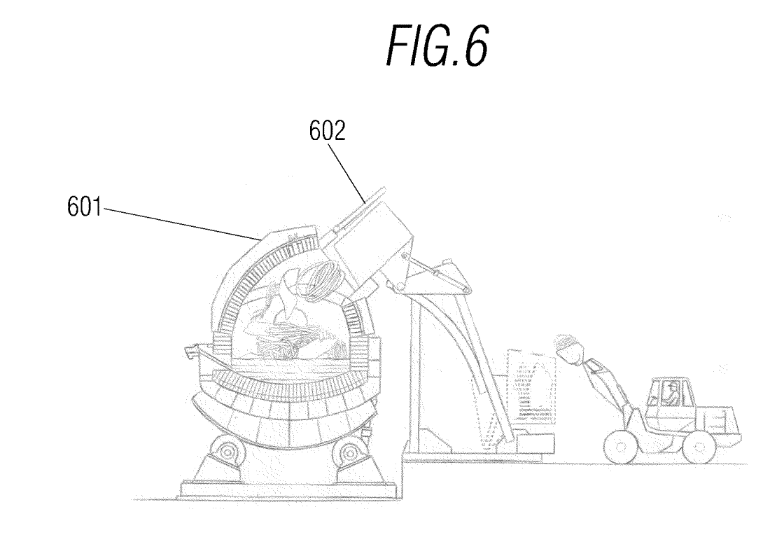

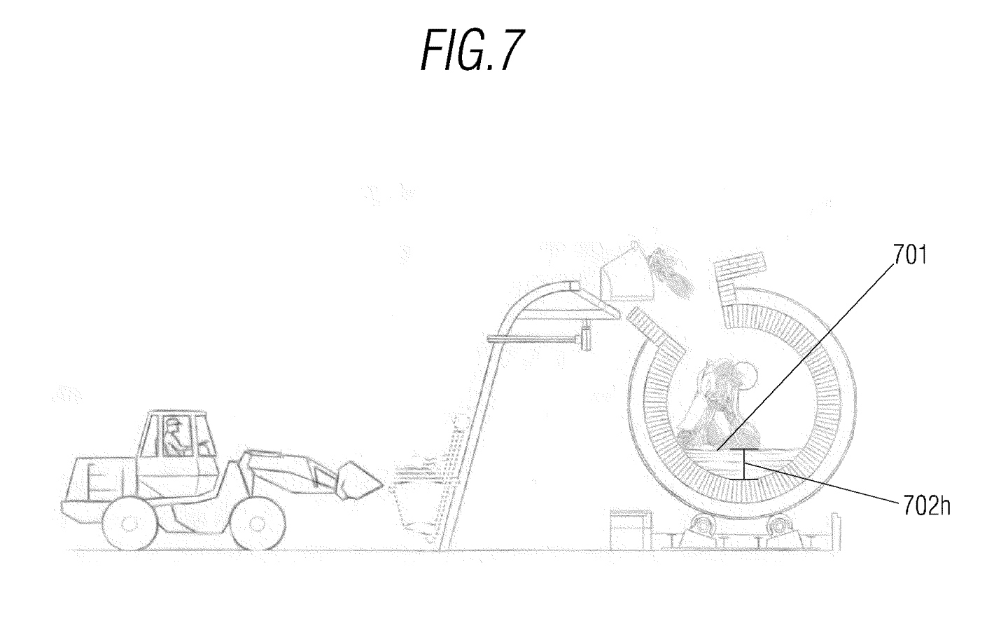

### DESCRIPTION OF A PREFERRED EMBODIMENT

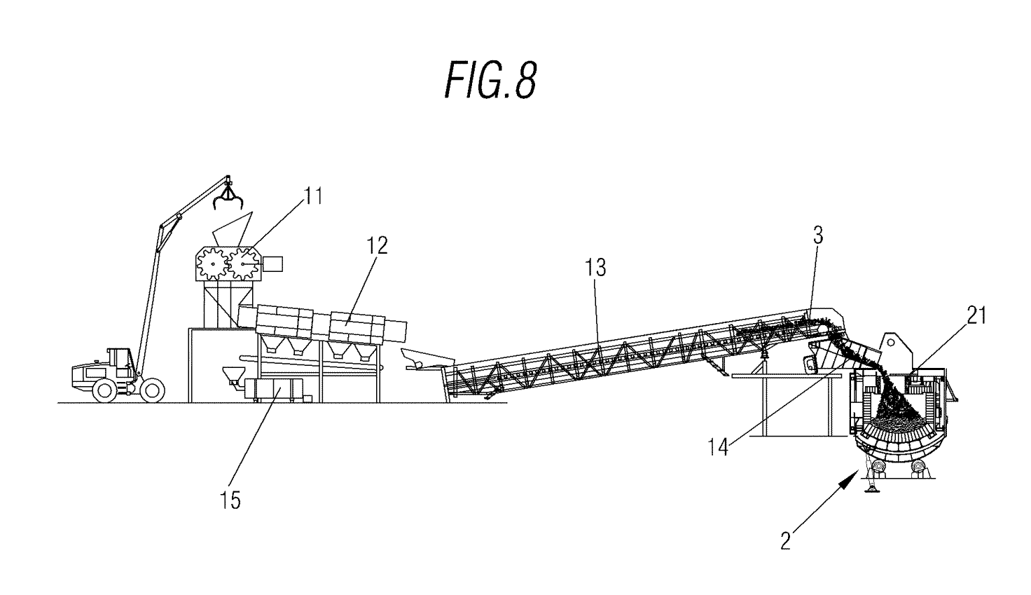

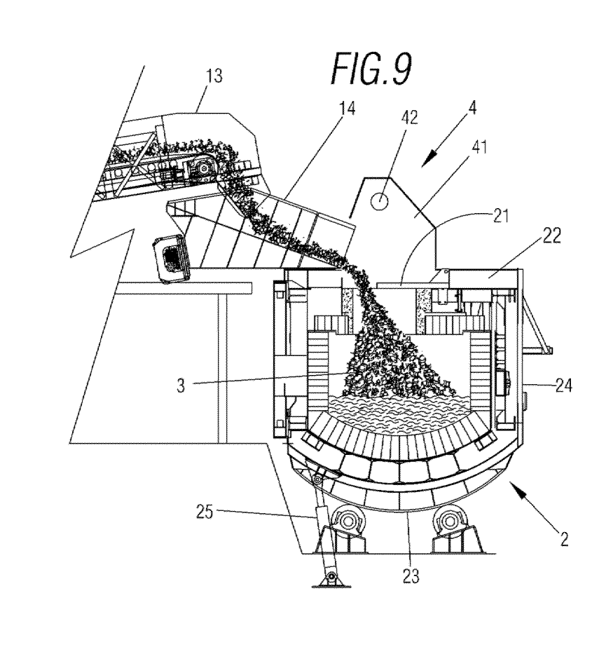

In light of the aforementioned FIGS. 8-11, in accordance with the adopted numbering, one may observe therein a preferred embodiment of the invention, which comprises the parts and elements indicated and described in detail below. In FIGS. 8 and 9 some non-visible elements have been represented in order to make the invention more readily understandable.

FIG. 8 shows a schematic view of the system for charging a furnace for melting and refining copper scrap. Said charging system preferably comprises a shredder 11 intended for receiving copper scrap to be refined. Said shredder may be of the cutter mill type, and may be fed by means of any suitable method. It will be obvious for those skilled in the art to modify the number and type of shredders 11 according to the particular needs of each case, such that it may be possible to obtain shredded scrap particle sizes of 100 to 150 mm in length, with a density of 800 to 960 kg/m³.

The shredder 11 is associated in turn with screening means 12 intended to receive copper scrap 3 shredded by said shredder 11. The screening means 12 may comprise a screening drum and/or a device for separating by vibration; these screening means 12 make it possible to separate in accordance with the diameter of the particles, and the particles with diameters smaller than the screening diameter are for the most part earth and other non-metal impurities. A collection system 15 has been provided for storing the particles of non-metal elements that have been separated from the copper scrap in the screening means 12, so that they may be properly processed and their impact on the environment may be minimized. These screening means 12 are linked to at least one vibrating feeder table 14 through continuous conveyance means 13, wherein the continuous conveyance means 13 preferably have a conveyor belt. This conveyor belt makes it possible to accumulate preferably between 5 and 25 tons of shredded copper scrap 3, depending on the capacity of the furnace 2 to be charged, between 50 and 500 tons. For example, a 10 to 25 m conveyor belt will be necessary in order to accumulate the required quantity of copper scrap of between 5 and 25 tons, using belts that are 700 mm to 1500 mm wide.

Said vibrating feeder table 14 is configured so as to make it possible to put the shredded copper scrap 3 into the furnace 2, preventing damage to the conveyor belt caused by the heat coming out of the charging door 21; in addition, said vibrating table 14 can move towards and away from the charging door 21 of the furnace in order to facilitate the charging tasks and to retract when it is not operating.

A preferred method for charging a furnace for melting and refining copper scrap comprises the following stages:

a) shredding the copper scrap to be refined; wherein the size of the shredded copper scrap particles 3 is made to be comprised advantageously between 100 and 150 mm in length;
b) screening out non-metal elements present in the copper scrap to be refined; wherein said non-metallic elements present in the copper scrap to be refined are principally earth materials.
c) conveyance of the copper scrap to be refined, through the continuous conveyance means 13 described above;
d) opening a charging door 21 of the furnace 2;
e) feeding the shredded copper scrap 3 to be refined into the furnace 2, particularly by vibration, thus improving the distribution of the material to be melted inside the furnace 2.

Advantageously, the presence of control systems (which have not been represented) may be provided, in order to manage the method described above; said control systems would effectively coordinate all of the components of the above charging system with the opening of the charging door 21 of the furnace 2, such that the charging door 21 would only be opened at the moment and for the duration strictly necessary for charging the shredded copper scrap 3. To open the charging door 21, an opening mechanism (not shown) may be used, which may be actuated by the control systems.

In carrying out this method, at least 5% of the total capacity of the furnace is put into the furnace 2 per minute, and the furnace 2 is opened a maximum of 20 times per full charge. This allows for the energy necessary to melt the copper scrap fed into the furnace to be reduced with respect to the known systems and methods, and for it to be less than 400 kWh/mt for a furnace with a capacity of 150 mt. In addition, a flow of secondary emissions of less than 3 kg/h per ton of furnace 2 capacity is extracted.

It may be observed in the attached figures that the present charging system may advantageously have at least one secondary-gas extraction unit 4, comprising a conduit 42 from the vicinity of the charging door 21 of the furnace 2 up to a gas cleaning station (not represented). Preferably, this secondary-gas extraction unit 4 also includes an outer casing 41 that acts as a fume hood to collect the secondary emissions generated when the charging door 21 is opened.

In FIG. 9 one may observe in detail the furnace 2 for melting and refining copper scrap, particularly of the tilting reverberatory type, which comprises a flat vault 22, wherein said flat vault 22 is equipped with a horizontal charging door 21, the opening of said charging door 21 being suitable for receiving a volume of shredded copper scrap 3 from the charging system described above. The maximum opening width necessary for the furnace 2 charging door 21 for charging shredded scrap 3 is less than 0.6 m, preferably equal to or less than 0.5 m. As for the opening surface of the furnace 2 charging door 21 for charging the shredded copper scrap 3, it is 0.45 m² to 0.9 m². In this case, the starting point was a tilting reverberatory furnace, since in order to properly carry out the process of melting and refining copper scrap with batch-type charging and melting, the surface of the molten metal needs to be large, and the depth of the molten metal should not exceed approximately 700 mm. Moving on to the characteristics of the furnace 2, the joining walls 24 between the furnace sole 23 and the vault 22 are vertical. The hydraulic cylinders 25 for tilting the furnace 2 may also be observed.

The vibrating table 14 has moved up to the end of the conveyor belt, which has been activated, and in this way the shredded copper scrap 3 is put into the furnace 2 at a speed of between 5 and 25 tons per minute. The charging door 21 of the furnace 2 is open to a width that is minimal and sufficient in order to correctly charge the furnace 2, for instance 500 mm, given copper scrap pieces with a maximum grain size of approximately 150 mm. This shredded material slides down the walls of the mound that is already present in the furnace 2.

The secondary emissions are channeled through the extraction conduit 42, which is preferably situated above the charging door 21 of the furnace 2. This extraction conduit 42 is located inside an enclosure or outer casing 41, which is preferably equipped with a side opening 43 which allows the furnace 2 to be charged safely.

Thus, the time and surface area that the charging door 21 is opened during the charging process is minimized with respect to other systems in the state of the art that limit this charging to the capacity of the conveyance systems and to the shape of the scrap, in turn generating a much smaller volume of secondary emissions to be processed, and also minimizing damage to the refractory walls of the furnace caused by heat shock.

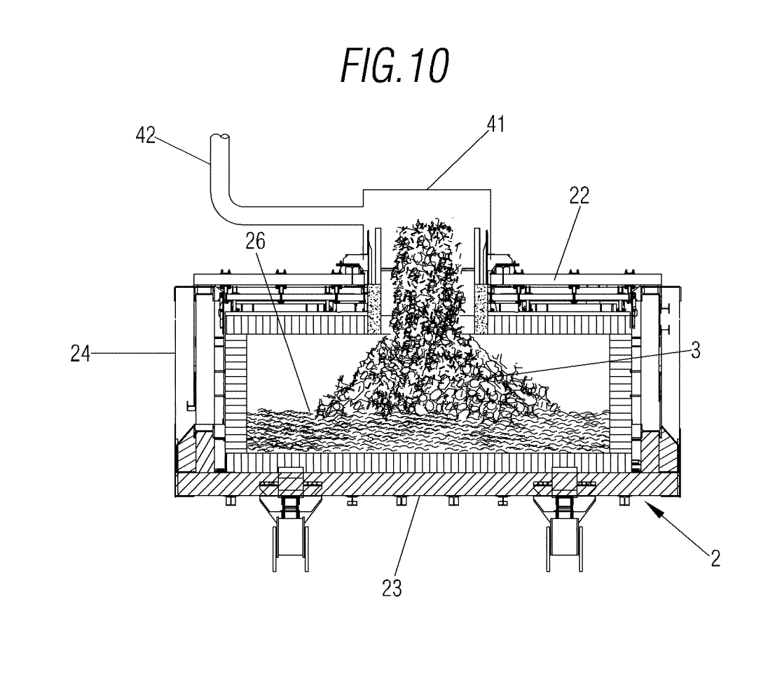

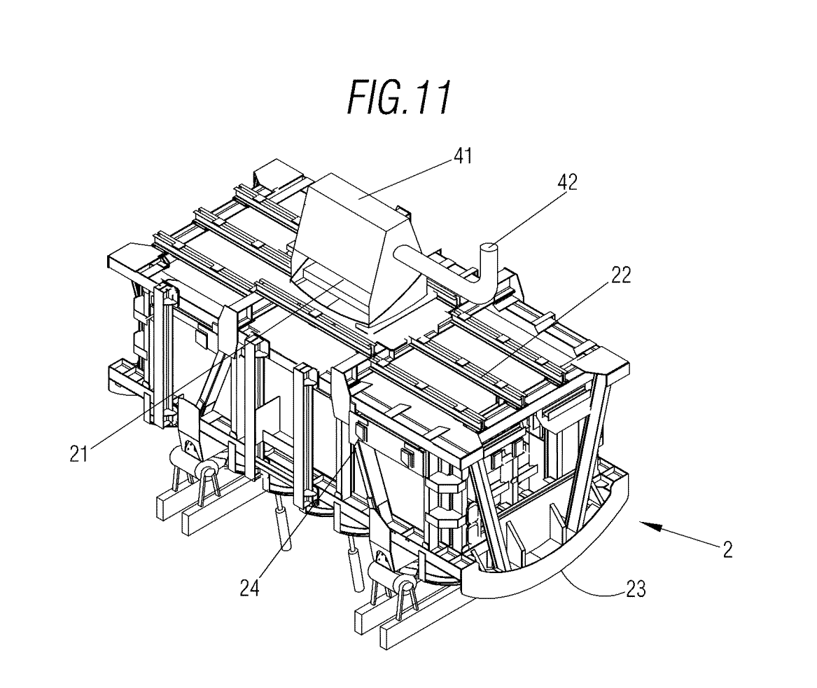

FIG. 10 shows a schematic view in longitudinal cross-section of the process of charging the furnace 2. It may be observed that the surface of the bath is large enough to promote a proper exchange between the additive and the liquid copper, with a maximum depth of approximately 700 mm. Depending on the capacity of the furnace 2, which is generally between 50 and 500 mt, surfaces of between 9 and 90 m² would preferably be obtained. FIG. 11 shows a view of the vault 22 of the furnace 2. Given the homogeneity and relatively small size of the shredded copper particles, the charging door 21 of the furnace 2 may be opened, as mentioned above, to a measure of no more than 500 mm, wherein the size of the charging door 21 may be between 900 and 1800 m in length, depending on the capacity of the furnace 2. Charging is carried out for one minute, opening up a 0.45 m² to 0.9 m² section. This relatively small opening makes it possible to easily collect the secondary emissions to carry them to the fumes cleaning facility (not represented). Likewise, as the material is free of earth and dust, much fewer polluting gases are generated. The secondary-gas extraction conduit 42 may be fitted to the vibrating table 14 or to the loading door 21 to prevent unnecessary aspiration losses. The mentioned measures may be subject to slight variation for each specific case.

Clearly, the loading door 21 allows for a larger opening, should larger-size solid pieces need to be charged, such as copper bases or solid pieces whose dimensions are too large to be allowed in the shredder 11.

When a gas is discharged between two large enclosures through an opening with diameter d, the expression (1A) determines the flow of gas discharged through a door in the enclosures:

$$W = 1.265 * {10}^{4} * Y * {d}^{2} * \sqrt{\frac{Δ p * p}{K * 10}} ( 1 ) \qquad ( 1 A )$$

| Variable | Symbol | Units |
|---|---|---|
| Pressure difference inside/outside the furnace | Δp | N/m² |
| Equivalent diameter of the opening in the furnace | d | M |
| Net expansion factor of compressible fluids | Y | |
| Density of the fluid | ρ | Kg/m³ |
| Coefficient of resistance or loss of load by speed | K | |
| Fluid mass flow | W | Kg/h |

The decrease in the volume of secondary emissions exiting the charging door 21 of the furnace 2 of this invention, as compared with conventional reverberatory furnaces, when applying the above formula, is quite considerable, specifically a ratio of 1 to 9. The average flow of gases to be processed is reduced from 3750 kg/h for a conventional reverberatory furnace to 417 kg/h in the furnace 2 of the invention, for furnaces with a capacity of 150 mt.

This means from 26 kg/h per ton of capacity to 3 kg/h per ton of capacity, regardless of the total capacity of the furnace.

This reduction in the gas flow makes it possible to reduce the size of the secondary extraction circuit, meaning smaller ducts and fans, with the corresponding savings on building materials and electric energy in the fans/aspiration turbines.

Likewise, the overall energy savings between a conventional reverberatory furnace and charging system, and the furnace and charging system described herein, due to the relatively small size of the charging door 21 opening, as well as the reduction in the times the charging door 21 must be opened during the charging process, make up between 20-25% of the energy needed to melt the material. Bearing in mind that in practice a conventional reverberatory furnace with a capacity of 150 mt requires 465 kWh/melted ton, this makes up savings of between 93-116 kWh/melted ton. This energy varies depending on the capacity of the furnace; preferably considering furnaces of between 50 and 500 mt, the energy necessary to melt the material in the furnace 2 of the present invention will oscillate between 540 kWh/mt and 250 kWh/mt, respectively.

Moreover, during the conventional process of charging a reverberatory furnace for refining copper scrap, at least 1.5% of earth is put into the furnace; this earth is heated up to the melting temperature of copper, and is subsequently removed as a component of the slag. As such, this earth element does not carry out any function in the process, and should be considered wasted energy; i.e. supplementary energy must be provided in order to heat up this earth.

The energy necessary (E) to bring a mass to a temperature is represented by expression 1B:

E=Mₑ*Cₑ*Tₘ (1B)

| Variable | Symbol | Units |
|---|---|---|
| Heat Capacity of the earth | Cₑ | kJ/(kg * ° C.) |
| Mass of earth delivered to the furnace | Mₑ | kg |
| Temperature Molten Metal | Tₘ | ° C. |

Wherein, by way of example, a Cₑ of 1.25 kJ/(kg*° C.) is considered, according to the literature, a temperature of approximately 1200° C., and an Mₑ of 2.25 mt of earth for a 150 mt furnace.

Therefore, it follows that the energy consumption when melting metal in the traditional system for charging copper scrap is, due to the presence of earth, at least 3.6% higher with respect to the charging system and furnace of the present invention.

The details, shapes, dimensions and other accessory elements, as well as the materials used to manufacture the system, the method and the furnace for refining copper scrap of the invention, may be suitably substituted for others which are technically equivalent, and do not diverge from the essential nature of the invention, nor the scope defined by the claims included below.

1. A system for charging a furnace for melting and refining copper scrap, comprising at least one shredder intended to receive copper scrap to be refined, associated in turn with a screen intended to receive copper scrap that that has been shredded by said shredder, wherein said screen is linked to at least one vibrating feeder table through a continuous conveyor, wherein said vibrating feeder table is configured so as to allow shredded copper scrap to be put into the furnace.

2. The system for charging a furnace for melting and refining copper scrap according to claim 1, wherein the screen comprises a screening drum and/or a device for separating by vibration.

3. The system for charging a furnace for melting and refining copper scrap according to claim 1, wherein the continuous conveyor has a conveyor belt.

4. The system for charging a furnace for melting and refining copper scrap according to claim 1, wherein said shredder is of the cutter mill type.

5. The system for charging a furnace for melting and refining copper scrap according to claim 1, wherein it has at least one secondary-gas extraction unit, comprising an extraction conduit from the vicinity of the charging door of the furnace, wherein said extraction conduit (42) may be linked to a gas cleaning station.

6. The system for charging a furnace for melting and refining copper scrap according to claim 1, wherein the size of the shredded copper scrap particles to be charged into the refining furnace is between 100 and 150 mm in length.

7. A furnace for melting and refining copper scrap, particularly of the tilting reverberatory type, wherein it comprises a flat vault, and said flat vault is equipped with a horizontal charging door, the opening of said charging door being suitable for receiving a volume of copper scrap from the charging system according to claim 1.

8. The furnace for melting and refining copper scrap according to claim 7, wherein the maximum opening width of the charging door of the furnace for charging the shredded copper scrap is less than 0.6 m.

9. The furnace for melting and refining copper scrap according to claim 7, wherein the maximum opening width of the charging door of the furnace for charging the shredded copper scrap is equal to or less than 0.5 m.

10. The furnace for melting and refining copper scrap according to claim 7, wherein the opening surface of the charging door of the furnace for charging the shredded copper scrap is from 0.45 m² to 0.9 m².

11. A method for charging a furnace for melting and refining copper scrap, wherein it comprises the following stages:
a) shredding the copper scrap to be refined;
b) screening out non-metal elements present in the copper scrap to be refined;
c) conveyance of the shredded copper scrap to be refined;
d) opening a charging door of the furnace;
e) feeding the shredded copper scrap to be refined into the furnace, particularly by vibration.

12. The method for charging a furnace for melting and refining copper scrap according to claim 11, wherein the size of the copper scrap particles shredded in stage a) is between 100 and 150 mm in length.

13. The method for charging a furnace for melting and refining copper scrap according to claim 11, wherein the non-metal elements present in the copper scrap to be refined are earth materials.

14. The method for charging a furnace for melting and refining copper scrap according to claim 11, wherein at least 5% of the total capacity of the furnace is put into the furnace per minute.

15. The method for charging a furnace for melting and refining copper scrap according to claim 11, wherein the charging door is opened to completely charge the furnace a maximum of 20 times.

16. The method for charging a furnace for melting and refining copper scrap according to claim 11, wherein a flow of secondary emissions of less than 3 kg/h per ton of furnace capacity is extracted.

17. The method for charging a furnace for melting and refining copper scrap according to claim 11, wherein the energy needed to melt the copper scrap fed into the furnace is less than 540 kWh/mt.
